(19) United States
(12) Patent Application Publication
(10) Pub. No.: US 2026/0300029 A1
(43) Pub. Date: Oct. 1, 2026

(54) DYNAMIC GROUP CIRCUIT FOR RESOURCE OPTIMIZATION IN CIRCUIT CUTTING EXECUTION

(71) Applicant: Dell Products L.P., Round Rock, TX (US)

(72) Inventors: Micael Veríssimo de Araújo, Rio de Janeiro (BR); João Victor da Fonseca Pinto, Rio de Janeiro (BR); Miguel Paredes Quiñones, Campinas (BR)

(21) Appl. No.: 19/095,297

(22) Filed: Mar. 31, 2025

(51) Int. Cl. G06F 9/50; G06N 10/40

(52) U.S. Cl. CPC G06F 9/5077; G06N 10/40

(57) ABSTRACT

Optimizing resources in quantum circuit execution operations. A quantum circuit may be cut into subcircuits. The subcircuits are grouped into one or more chunks based on estimated execution times and/or estimated memory requirements. Grouping the subcircuits allows the number of jobs to be executed in quantum computing systems to be reduced. The jobs are executed and final states associated with the jobs are knitted together to determine a final state of the original quantum circuit.

### TECHNOLOGICAL FIELD OF THE DISCLOSURE

Embodiments disclosed herein generally relate to quantum computing and orchestrating the execution of quantum computing workloads. More particularly, at least some embodiments relate to systems, hardware, software, computer-readable media, and methods for quantum circuit cutting operations and quantum circuit execution operations.

### BACKGROUND

High performance computing (HPC) workloads relate to workloads that are costly in terms of computational requirements (e.g., time and hardware) and economics. Because of the high computational requirements, HPC workloads are often executed in a distributed mode across multiple computing nodes.

When the workload relates to executing a quantum circuit, the complexity of orchestrating and executing the quantum circuit increases exponentially. One attempt to resolve this issue is to cut the quantum circuit into smaller quantum circuits. However, this may inadvertently increase orchestration time even if the actual quantum circuit execution time is reduced.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of an orchestration system configured to execute or manage execution of workloads in quantum and/or classical computing environments.

FIG. 2 discloses aspects of orchestrating the execution of a workload such as a quantum circuit;

FIG. 3 discloses additional aspects of orchestrating the execution of a workload such as a quantum circuit;

FIG. 4 discloses aspects of a method for orchestrating the execution of a workload such as a quantum circuit; and

FIG. 5 discloses aspects of a computing device, a computing system, or a computing entity.

### DETAILED DESCRIPTION OF SOME EXAMPLE EMBODIMENTS

Embodiments disclosed herein generally relate to quantum computing and quantum computing workloads. More particularly, at least some embodiments relate to systems, hardware, software, computer-readable media, and methods for tasks including cutting quantum circuits and/or executing quantum circuits that have been cut.

Quantum circuits (QC) are examples of workloads that are executed in quantum computing units or systems (QPUs). The QPUs may be real or emulated (e.g., emulated in classical computing environments). The complexity of executing quantum circuits increases exponentially with a size of the quantum circuit (e.g., the number of qubits and depth). Real quantum hardware are able to handle larger inputs efficiently due to the nature of the quantum computing paradigm.

Although quantum circuits may be executed in real quantum hardware and this possibility is not omitted from embodiments of the invention, embodiments of the invention are configured to reduce classical hardware requirements for executing quantum workloads in classical computing systems. Embodiments of the invention may reduce the need for HPC and allow a workload to be distributed to nodes as needed.

Executing quantum circuits on classical computing environments, in contrast, may require an HPC environment, particularly as the size of the quantum circuit increases. When performing tasks related to executing quantum circuits, Quantum Intelligent Orchestration (QIO) (an orchestrator or orchestration system) may advantageously estimate the amount of resources needed to run the quantum circuit (the workload or job), allocate the node to run the workload, monitor the process and take any action in case of issue during the workload time-life.

The complexity of workloads or problems involving quantum and classical areas is often high. In other words, orchestrating the execution of a workload may include aspects of managing or controlling classical computing resources and real quantum computing resources. As a result, a workload may be divided into many tasks. The tasks may include tasks executed in classical computing and tasks that may be executed in a real quantum systems.

In terms of tasks related to quantum circuit execution, these tasks may be categorized into predefined task types. For example, a quantum circuit execution workflow may include tasks such as quantum circuit transpilation, quantum circuit cutting (cutting an original quantum circuit into smaller quantum circuits or subcircuits), executing the smaller quantum circuits, and knitting the results together to determine a solution or final state of the original quantum circuit.

In each of these tasks, a resource estimation strategy may assist the orchestrator for job allocation purposes. For example, with regard to a circuit cutting task, performing the circuit cutting stage may cut a large or original quantum circuit into a large number of smaller quantum circuits (subcircuits). The final result or final state of the original quantum circuit is determined during a knitting stage or task that merges the results or final states of the smaller quantum circuits.

Embodiments of the invention relate to reducing or minimizing resource requirements (e.g., amount, time) related to performing quantum circuit related tasks by aggregating smaller quantum circuits into a single job. Thus, multiple smaller quantum circuits can be executed as a single job, which reduces the number of jobs sent to QPUs. More specifically in one example, a group of subcircuits can be sent to a particular QPU as a single job even if the subcircuits are executed in succession or in parallel. If executed on a real QPU, the subcircuits may be executed at the same time using different qubits (if available) for the subcircuits.

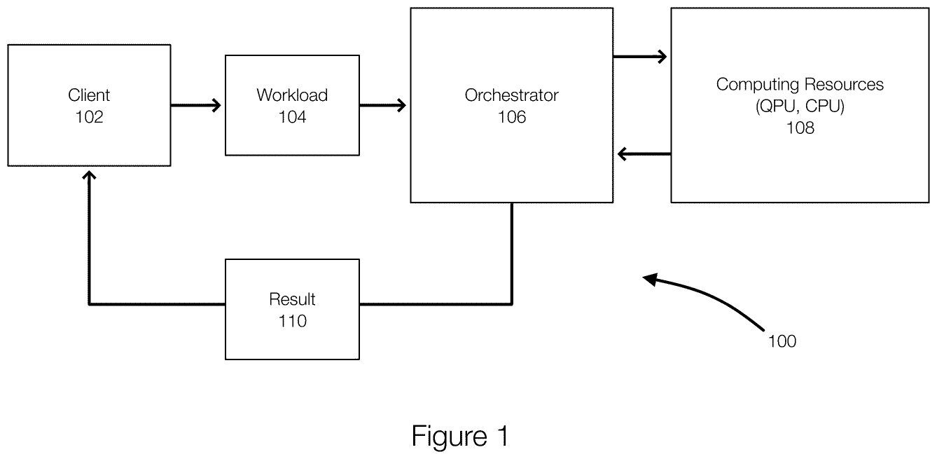

FIG. 1 discloses aspects of an orchestration system configured to execute or manage execution of workloads, such as quantum circuits in quantum and/or classical computing environments. An orchestration system 100 configured to orchestrate the execution of workloads may include an orchestrator 106. The orchestrator 106 may be implemented in a computing system including processors, memory, and other hardware. The orchestrator 106 may be a server system for example. The orchestrator 106 may be a near-edge system, a far-edge system, a cloud based system, an on-premise system, or the like or combination thereof.

In one example, a client 102 may submit a workload 104 to the orchestrator 106. The orchestrator 106 may perform various tasks on the workload 104 that may depend on the form or format of the workload 104. The orchestrator 106 may perform these tasks using computing resources (e.g., QPU, CPU (computer processing unit with processors, memory)). Once the workload 104 is completed, a result 110 (e.g., a final state) may be returned to the client 102.

In one example, the workload 104 includes or is a quantum circuit. The orchestrator 106 may perform various tasks on the workload 104 that may include transpilation (e.g., preparing a quantum circuit as input to a particular quantum processing unit). In addition to transpilation, other tasks may include circuit cutting, quantum circuit execution, knitting operations, and the like. Some of the tasks may be performed using real or emulated QPU and some of the tasks may be performed in classical computing systems (e.g., CPU).

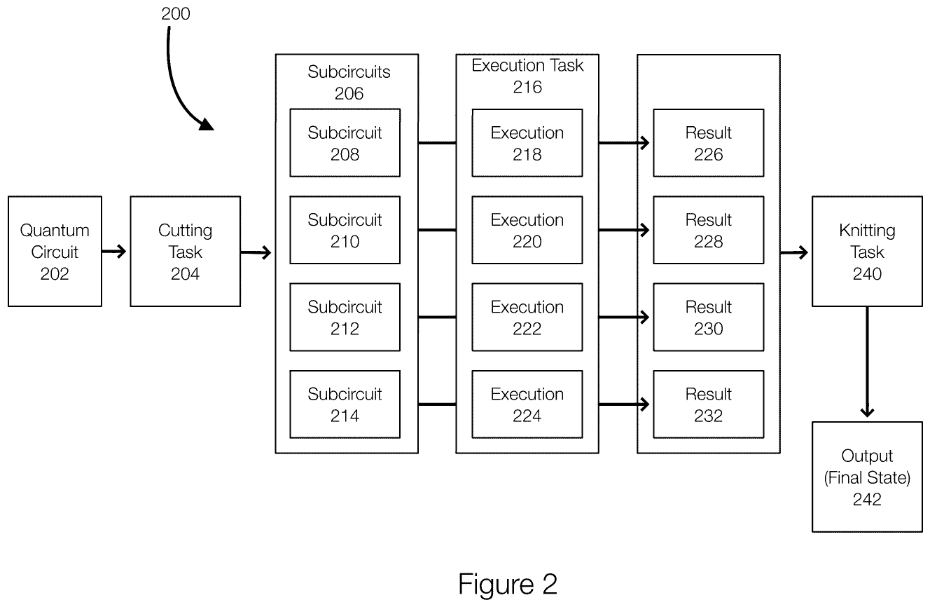

FIG. 2 illustrates aspects of orchestrating the execution of a workload such as a quantum circuit. FIG. 2 further illustrates examples of tasks that may be performed on a workload and embodiments of the invention are not limited thereto. Further, the order of some operations is not necessarily fixed and may vary from one workload to the next workload.

In FIG. 2, a quantum circuit 202 is received at an orchestration system 200. The orchestration system 200 may perform a cutting task 204, which may occur after determining that the quantum circuit 202 needs to be cut. For example, the quantum circuit 202 may require more qubits than what are available in a QPU or have an excessive anticipated execution time. A decision to cut the quantum circuit may be made based on anticipated performance improvements.

In this example of FIG. 2, the workflow for performing a workload represented by the quantum circuit 202 includes generating or performing a cutting task 204. The cutting task 204 receives the quantum circuit 202 as input and generates subcircuits 208, represented by subcircuits 208, 210, 212, and 214, as output. The subcircuits 206 are examples of jobs that may be submitted to a QPU, whether real or emulated in classical computing. In some examples, the cutting operation is a combinatorial operation and, as a result, the number of subcircuits can be large.

The next task performed by the orchestration system 200 is an execution task 216. The subcircuits 206 constitute an input to the execution task 216 and the output is results (or final states) obtained after executing the subcircuits 206 in QPUs.

In the execution task 216, QPUs are selected for each of the subcircuits 206 and the subcircuits 206 are executed at the selected QPUs. The executions the subcircuits 208, 210, 212, 214 are represented, respectively, by executions 218, 220, 222, 224. The subcircuits 206 are executed and results or final states, represented by results 226, 228, 230, 232 are obtained.

The orchestration system 200 may next identify and perform a knitting task 240, which knits the results 226, 228, 230, and 232 into an output 242. Thus, the output 242 is a result, solution, or final state of the quantum circuit 202.

As previously stated, the cutting task 204 can produce a large number of smaller quantum circuits (e.g., the subcircuits 206). The subcircuits 206 individually do not require the computing requirements of the quantum circuit 202. However, a set of resources is still required for each of the subcircuits 206 to be executed by the orchestration system 200. This may require some of these jobs (e.g., executing a subcircuit) to be queued. Due to the smaller sizes of the subcircuits 206, compared at least to the original quantum circuit 202, embodiments of the invention aggregate or group multiple subcircuits into a single job. This advantageously minimizes the effort of the orchestration system 200 (or the orchestrator) to allocate these jobs to the QPUs. Allocating a smaller number of jobs requires less resources compared to allocating a larger number of jobs.

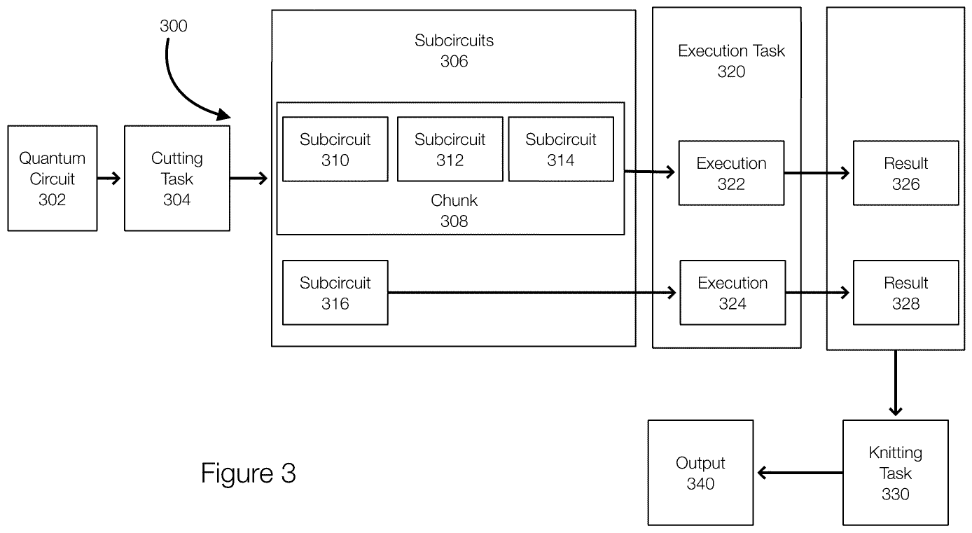

FIG. 3 discloses additional aspects of orchestrating the execution of a workload such as a quantum circuit. The orchestration system 300, which is an example of the orchestration system 100, receives a quantum circuit 302 and determines to perform a cutting task 304. In this example, the quantum circuit 302 is cut into subcircuits 306, which includes the subcircuits 310, 312, 314, and 316.

The orchestration system 300 next determines to perform an execution task 320. In this example, the orchestration system 300 (or the orchestrator) understands the nature of the execution task. An example nature is to run a subcircuit using a state-vector simulation. This allows the orchestrator to calculate or determine the amount of resources (e.g., both memory and time) using a memory estimate and a time estimate for each of the jobs (the subcircuits 306) to be executed in QPUs.

In this example, the jobs being considered include the subcircuits 306. Using the memory estimate and/or the time estimate, the subcircuits 306 can be grouped into chunks. FIG. 3 illustrates that the subcircuits 310, 312, and 314 are included in a chunk 308 and the subcircuit 316 is, in effect, its own chunk.

In one example, grouping or chunking the subcircuits 306 is based on the time estimates of the individual subcircuits. In one example, a threshold time period may be identified. A time estimate may be determined for each of the subcircuits 306. The time estimate may refer to performing one or more tasks or operations. An example time estimate may account for scheduling the job, anticipated execution time, and/or other routines and operations.

Next, a threshold time bound is set. Once the threshold time bound is set and the time estimates of the individual subcircuits are determined, the subcircuits 306 can be grouped into groups or chunks. For example, if the threshold time bound is 1 hour and the time estimates of the subcircuits 310, 312, and 314 are each 19 minutes, the subcircuits 310 312, and 314 may be grouped into a single job (e.g., the chunk 308). Thus, subcircuits may be grouped into a single group as long as their aggregate time estimate is below the threshold time bound. In one example, all of the subcircuits whose time estimate is below the threshold time bound can be analyzed and grouped. This advantageously reduces the number of jobs to be orchestrated.

The memory estimate for each job may also be determined. This allows the orchestrator to allocate sufficient memory for each of the jobs, regardless of how many subcircuits are included in each of the jobs.

Once the subcircuits 306 are chunked or grouped, the execution task 320 is determined. Thus, QPUs for the jobs (e.g., the chunk 308 and the subcircuit 316) are identified and the jobs are executed at the identified QPUs. Thus, an execution 322 is performed on the chunk 308 to generate a result 326 and the execution 324 is performed on the subcircuit 316 to generate a result 328. A knitting task 330 is performed to knit or merge the results 326 and 328 together to generate the output 340, which is a solution or final state of the quantum circuit 302.

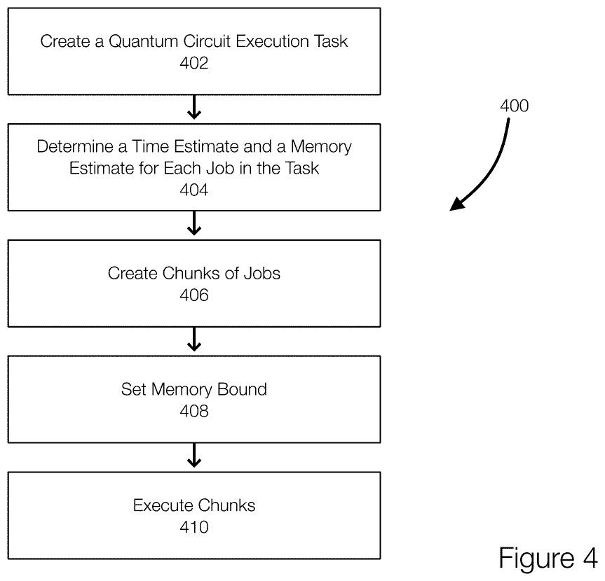

FIG. 4 discloses aspects of a method for orchestrating the execution of a workload such as a quantum circuit. The method 400 includes creating 402 or performing a quantum circuit execution task. More specifically, the quantum circuit execution task may be created after performing a cutting task, in which a quantum circuit has been cut into subcircuits. Each of the subcircuits may be referred to as a job. Thus, the quantum circuit execution task T_{Q} is to perform or execute a set of n quantum jobs. Embodiments of the invention reduce the number of jobs to be orchestration by chunking the n quantum jobs into a smaller number of jobs, some of which may include multiple subcircuits.

In one example, the orchestrator understands the nature of the task T_{Q} and is able to compute or determine 404 a memory estimate Mₘₑₘ and a time estimate Mₜᵢₘₑ for each of the jobs in the task T_{Q}. In other words, Mₘₑₘ and Mₜᵢₘₑ are determined for each job jᵢ∈T_{Q}.

In one example, the memory estimate and the time estimate of each job may be determined by a machine learning model M (estimate model) The estimate model may be trained using historical data such as circuit features, simulation configurations, an acyclic graph, statistics such as two-qubit gates count, one qubit gate count, and the like. This allows memory consumption and time requirements to be estimated by the estimate model.

Next, chunks are created 406 or defined. In one example, a set

$${T}_{{Q}_{1}} = \{ {j}_{i} \vert ∀ {M}_{time} ( {j}_{i} ) < {t}_{0} \} ⊂ {T}_{Q}$$

of all quantum jobs that run in less time than t₀ are identified. In one example, t₀ is a parameter to be used as upper bound (a time threshold bound (. An example of t₀ may be the time needed for the orchestrator perform a loop that includes: scheduling, planning, and other internal routines.
Next, k small chunk subsets

$${C}_{{Q}_{1}}^{k} = \{ {j}_{i} \vert \sum {M}_{time} ( {j}_{i} ) < {t}_{0} \} ⊂ {{T}_{Q}}_{1}$$

are created. In this example,

$${T}_{{Q}_{1}} = {⋃}_{k} {C}_{{Q}_{1}}^{k} .$$

This allows a new task

$${T}_{{Q}_{1}}^{′}$$

with k jobs called

$${j}_{i}^{k}$$

that are composed by each one of

$${C}_{{Q}_{1}}^{k} .$$

In one example,

$${T}_{{Q}_{1}}^{′}$$

are the fastest jobs to run that were grouped into small chunks to be orchestrated separately. With this configuration and in this particular example, each

$${j}_{i}^{k}$$

will have

$$\vert {C}_{{Q}_{1}}^{k} \vert$$

circuits to run.

Finally, the task T_{Q} can be written as

$${T}_{Q} = {T}_{{Q}_{1}}^{′} ⋃ ( {T}_{Q} - {T}_{{Q}_{1}}^{′} ) .$$

Each item in the task or set

$${T}_{{Q}_{1}}^{′}$$

may be a chunk that includes multiple jobs (multiple subcircuits) as illustrated in FIG. 3.

Next, a memory bound is determined and set 408 for the task T_{Q}. For each item in the task T_{Q}, the memory upper bound is determined using the estimate model. If the item is a group of jobs (a chunk), all jobs in the group are considered. Finally, the task T_{Q} is sent for execution. Advantageously, because some of the jobs were grouped into chunks based on the time estimates, the number of items in the task T_{Q} is reduced compared to the number of items in the initial task configuration. Jobs, including jobs that include multiple subcircuits, can be allocated based on estimated time, estimated memory requirements, and the like.

Embodiments of the invention allow the orchestrator to automatically manage jobs and reduce the time required to schedule and execute jobs at least because the jobs have been reorganized or reconfigured by the orchestrator into chunks or groups. In some examples, resources are saved or managed more efficiently at least because small jobs are grouped into a single job and send to a unique node to be executed.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, near-identity circuit generation operations, quantum circuit obfuscation operations, quantum circuit execution operations, quantum circuit orchestration operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide functionality for one or more clients. Another example of a cloud computing environment is one in which processing, quantum circuit execution, data protection, and other, services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope.

Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a quantum circuit at an orchestrator configured to orchestrate an execution of the quantum circuit, cutting the quantum circuit into subcircuits, wherein each of the subcircuits constitutes an initial job, grouping at least some of the subcircuits into chunks, determining final jobs that include the chunks and subcircuits not included in the chunks, wherein a number of final jobs is less than a number of the initial jobs, executing the final jobs in one or more quantum computing systems, and determining a final state of the quantum circuit from final states of the subcircuits included in the final jobs.

Embodiment 2. The method of embodiment 1, wherein the grouping at least some of the subcircuits into chunks further comprises determining a time estimate for each of the subcircuits.

Embodiment 3. The method of embodiment 1 and/or 2, further comprising grouping subcircuits having a time estimate less than a threshold time bound into the chunks.

Embodiment 4. The method of embodiment 1, 2, and/or 3, further comprising determining a memory estimate for each of the chunks and for each of the subcircuits not included in the chunks.

Embodiment 5. The method of embodiment 1, 2, 3, and/or 4, further comprising allocating the final jobs to nodes based on the memory estimate and the time estimates.

Embodiment 6. The method of embodiment 1, 2, 3, 4, and/or 5, further comprising training a model to generate the time estimates and the memory estimates.

Embodiment 7. The method of embodiment 1, 2, 3, 4, 5, and/or 6, further comprising performing a knitting operation on the final states of the subcircuits to determine the final state of the quantum circuit.

Embodiment 8. The method of embodiment 1, 2, 3, 4, 5, 6, and/or 7, further comprising transpiling the quantum circuit.

Embodiment 9. The method of embodiment 1, 2, 3, 4, 5, 6, 7, and/or 8, wherein each of the chunks includes a same number of subcircuits.

Embodiment 10. The method of embodiment 1, 2, 3, 4, 5, 6, 7, 8, and/or 9, wherein the one or more quantum computing systems are classical computing systems configured to execute quantum workloads.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

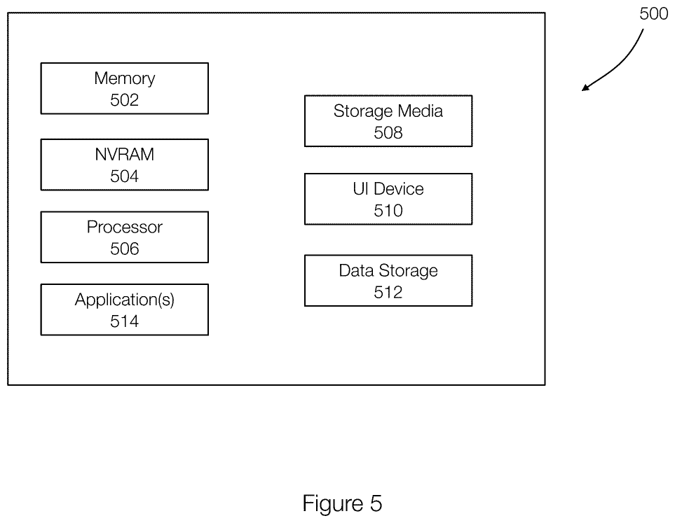

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may be configured to perform quantum operations as a simulated or emulated quantum processing unit. The device 500 may also be used in aspects of orchestrating the execution of a quantum circuit in a QPU, which may include obfuscating a quantum circuit to generate an obfuscated quantum circuit.

The described embodiments are to be considered in all respects only as illustrative and not restrictive. All changes which come within the meaning and range of equivalency of the claims are to be embraced within their scope.

What is claimed is:

1. A method comprising:
receiving a quantum circuit at an orchestrator configured to orchestrate an execution of the quantum circuit;
cutting the quantum circuit into subcircuits, wherein each of the subcircuits constitutes an initial job;
grouping at least some of the subcircuits into chunks;
determining final jobs that include the chunks and subcircuits not included in the chunks, wherein a number of final jobs is less than a number of the initial jobs;
executing the final jobs in one or more quantum computing systems; and
determining a final state of the quantum circuit from final states of the subcircuits included in the final jobs.

2. The method of claim 1, wherein the grouping at least some of the subcircuits into chunks further comprises determining a time estimate for each of the subcircuits.

3. The method of claim 2, further comprising grouping subcircuits having a time estimate less than a threshold time bound into the chunks.

4. The method of claim 3, further comprising determining a memory estimate for each of the chunks and for each of the subcircuits not included in the chunks.

5. The method of claim 4, further comprising allocating the final jobs to nodes based on the memory estimate and the time estimates.

6. The method of claim 5, further comprising training a model to generate the time estimates and the memory estimates.

7. The method of claim 6, further comprising performing a knitting operation on the final states of the subcircuits to determine the final state of the quantum circuit.

8. The method of claim 1, further comprising transpiling the quantum circuit.

9. The method of claim 1, wherein each of the chunks includes a same number of subcircuits.

10. The method of claim 1, wherein the one or more quantum computing systems are classical computing systems configured to execute quantum workloads.

11. A non-transitory storage medium having stored therein instructions that are executable by one or more hardware processors to perform operations comprising:
receiving a quantum circuit at an orchestrator configured to orchestrate an execution of the quantum circuit;
cutting the quantum circuit into subcircuits, wherein each of the subcircuits constitutes an initial job;
grouping at least some of the subcircuits into chunks;
determining final jobs that include the chunks and subcircuits not included in the chunks, wherein a number of final jobs is less than a number of the initial jobs;
executing the final jobs in one or more quantum computing systems; and
determining a final state of the quantum circuit from final states of the subcircuits included in the final jobs.

12. The non-transitory storage medium of claim 11, wherein the grouping at least some of the subcircuits into chunks further comprises determining a time estimate for each of the subcircuits.

13. The non-transitory storage medium of claim 12, further comprising grouping subcircuits having a time estimate less than a threshold time bound into the chunks.

14. The non-transitory storage medium of claim 13, further comprising determining a memory estimate for each of the chunks and for each of the subcircuits not included in the chunks.

15. The non-transitory storage medium of claim 14, further comprising allocating the final jobs to nodes based on the memory estimate and the time estimates.

16. The non-transitory storage medium of claim 15, further comprising training a model to generate the time estimates and the memory estimates.

17. The non-transitory storage medium of claim 16, further comprising performing a knitting operation on the final states of the subcircuits to determine the final state of the quantum circuit.

18. The non-transitory storage medium of claim 11, further comprising transpiling the quantum circuit.

19. The non-transitory storage medium of claim 11, wherein each of the chunks includes a same number of subcircuits.

20. The non-transitory storage medium of claim 11, wherein the one or more quantum computing systems are classical computing systems configured to execute quantum workloads.
